(19) United States
(12) Patent Application Publication
(10) Pub. No.: US 2015/0062058 A1
(43) Pub. Date: Mar. 5, 2015

(54) TOUCH PANEL CAPABLE OF DETECTING A STYLUS AND A METHOD OF USING THE SAME

(71) Applicant: Himax Technologies Limited, Tainan City (TW)

(72) Inventors: Chung-Wen Chang, Tainan City (TW); Shen-Feng Tai, Tainan City (TW); Jui-Min Liu, Tainan City (TW); Chun-Kai Chuang, Tainan City (TW)

(73) Assignee: Himax Technologies Limited, Tainan City (TW)

(21) Appl. No.: 14/016,521

(22) Filed: Sep. 3, 2013

(51) Int. Cl. G06F 3/0354; G06F 3/044

(52) U.S. Cl. CPC G06F 3/03545; G06F 3/044
USPC 345/174

(57) ABSTRACT

A touch panel capable of detecting a stylus is disclosed. At least one self scan cycle and at least one mutual scan cycle are performed in each scan frame, and touch identification of the stylus is affirmed when both touch identifications via the self scan cycle and the mutual scan cycle are detected.

### BACKGROUND OF THE INVENTION

1. Field of the Invention

The present invention generally relates to a touch panel, and more particularly to a touch panel capable of detecting a stylus.

2. Description of Related Art

A stylus is an accessory tool that is ordinarily used to assist in navigation when using a touch screen. The stylus tip is normally too small to be sensed by a common touch screen. A specially made stylus or capacitive stylus is therefore required when using a common touch screen.

A conventional stylus such as a capacitive stylus, however, requires substantive manufacture process and associated cost. Moreover, the capacitive stylus cannot be easily replaced in case of malfunction, being left behind or circumstances involving loss.

For the foregoing reasons, a need has arisen to propose a novel scheme to detect a stylus, particularly a stylus that is not specially made, to provide more convenience for a user using a common touch screen.

### SUMMARY OF THE INVENTION

In view of the foregoing, it is an object of the embodiment of the present invention to provide a touch panel and an associated method capable of detecting a stylus in a manner more effectively and accurately than a conventional touch panel.

According to one embodiment, a touch panel capable of detecting a stylus includes a plurality of row electrodes disposed along a first axis, and a plurality of column electrodes disposed along a second axis. Mutual capacitance is at every intersection of each row electrode and each column electrode, and self capacitance is at each row electrode and each column electrode. A voltage is applied to the column electrode or row electrode during a self scan cycle, and the stylus touching on a surface of the touch panel is measured on the same column electrode or row electrode. A voltage is applied to one axis during a mutual scan cycle, and the stylus touching on the surface of the touch panel is measured on the other axis. At least one self scan cycle and at least one mutual scan cycle are performed in each scan frame, and touch identification of the stylus is affirmed when both touch identifications via the self scan cycle and the mutual scan cycle are detected.

### BRIEF DESCRIPTION OF THE DRAWINGS

FIG. 1 shows a schematic diagram illustrative of a touch panel according to one embodiment of the present invention;

FIG. 2 shows a schematic diagram exemplifying a series of scan frames;

FIG. 3A shows self raw data with respect to a predetermined self touch threshold;

FIG. 3B shows mutual raw data with respect to a predetermined mutual touch threshold;

FIG. 4 shows a flow diagram of identifying touch action of a stylus according to one embodiment of the present invention;

FIG. 5 shows a flow diagram of relieving touch action of a stylus according to one embodiment of the present invention; and

FIG. 6 shows an alternative flow diagram of relieving touch action of a stylus according to another embodiment of the present invention.

### DETAILED DESCRIPTION OF THE INVENTION

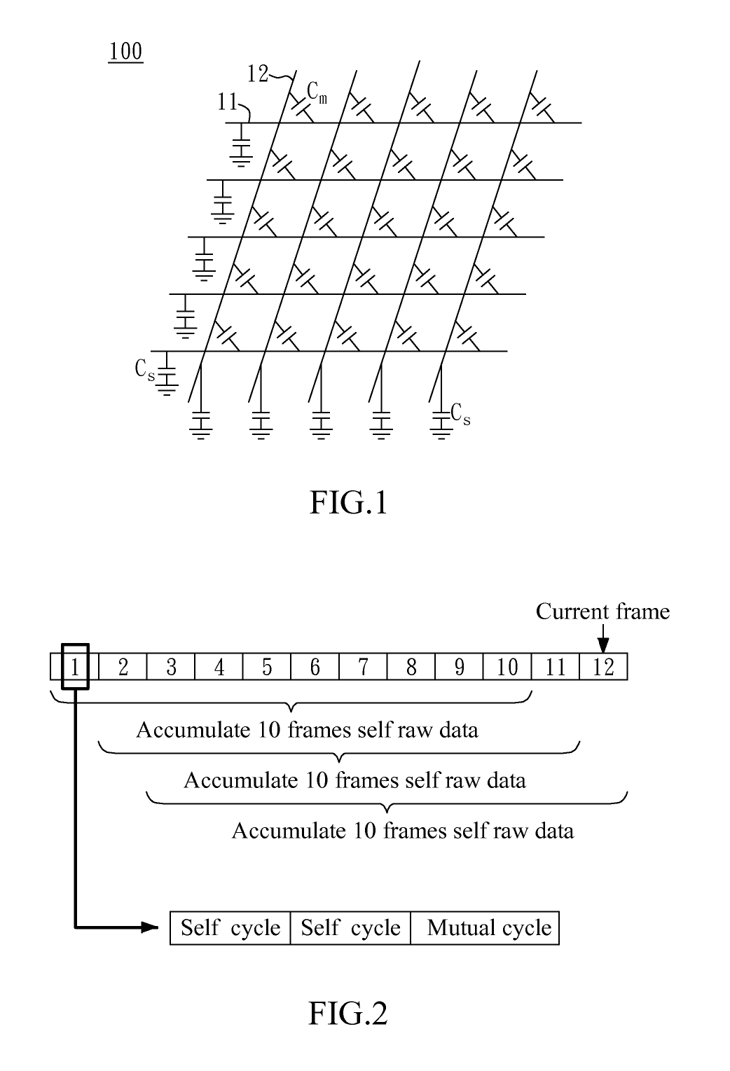

FIG. 1 shows a schematic diagram illustrative of a touch panel 100 according to one embodiment of the present invention. The touch panel 100 of the embodiment may be employed in an electronic device, such as a mobile phone. The touch panel 100, for example, a capacitive touch panel, is composed of row electrodes 11 and column electrodes 12. There is mutual capacitance Cₘ at every intersection of each row electrode 11 and each column electrode 12; and there is self capacitance Cₛ at each row electrode 11 and each column electrode 12. The touch panel 100 of the embodiment is capable of detecting a stylus to perform an associated function in a manner more effectively and accurately than a conventional touch panel. The stylus mentioned in the embodiment may be referred to a general stylus that need not be a specifically made or tailor-made capacitive stylus.

Still referring to FIG. 1, regarding the self capacitance Cₛ, a voltage may be applied to the column electrode 12 or row electrode 11 during a self scan cycle, and a stylus touching on a front (or touch) surface of the touch panel 100 may thus be measured on the same column electrode 12 or row electrode 11 by a detect circuit (not shown). Regarding the mutual capacitance Cₘ, a voltage may be applied to one axis (e.g., a column electrode 12) during a mutual scan cycle, and the stylus touching on the front surface of the touch panel 100 may thus be measured on the other axis (e.g., a row electrode 11) by the detect circuit.

FIG. 2 shows a schematic diagram exemplifying a series of scan (or measurement) frames. According to one aspect of the embodiment, self raw data (associated with the self capacitance Cₛ) of a plurality of preceding scan frames (e.g., 10 scan frames as exemplified in FIG. 2) may be accumulated. As intensity of the self raw data is commonly weak while detecting a stylus, the accumulation of the self raw data of the scan frames may thus enhance touch sensitivity.

According to another aspect of the embodiment, still referring to FIG. 2, a plurality of same self scan cycles (e.g., two self scan cycles as exemplified in FIG. 2) may be performed in each scan frame, and self raw data of the self scan cycles are then added. Accordingly, the added self raw data of the self scan cycles may capably enhance detecting sensitivity of the touch panel 100.

According to a further aspect of the embodiment, still referring to FIG. 2, in addition to one or more self scan cycles performed in each scan frame, at least one mutual scan cycle is also performed in each scan frame as exemplified in FIG. 2. Mutual raw data (associated with the mutual capacitance Cₘ) of the performed mutual scan cycle may be utilized to affirm the touch identification of a stylus touching on a surface of the touch panel 100. For example, in the embodiment, touch identification may be affirmed only when both touch identifications via the self scan cycle(s) and the mutual scan cycle(s) are detected. That is, in the embodiment, failure of either self scan cycle(s) or mutual scan cycle(s) defeats the touch identification. The performances of both the self scan cycle(s) and the mutual scan cycle(s) may be used to resist influence on the touch panel 100 due to environment change.

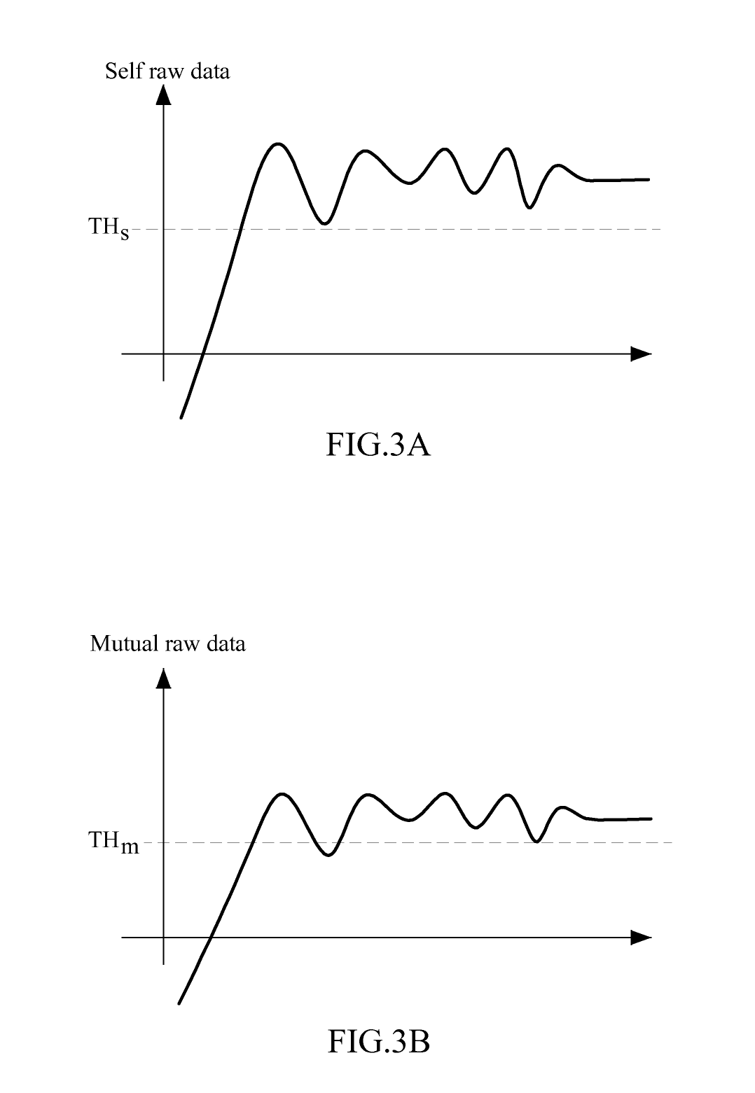

In the embodiment, regarding the self capacitance Cₛ, the touch identification is detected when self raw data (of one or more self scan cycles in a scan frame) is greater than a predetermined self touch threshold THₛ as illustrated in FIG. 3A. Regarding the mutual capacitance Cₘ, the touch identification is detected when mutual raw data (of at least one scan cycle in a scan frame) is greater than a predetermined mutual touch threshold THₘ as illustrated in FIG. 3B.

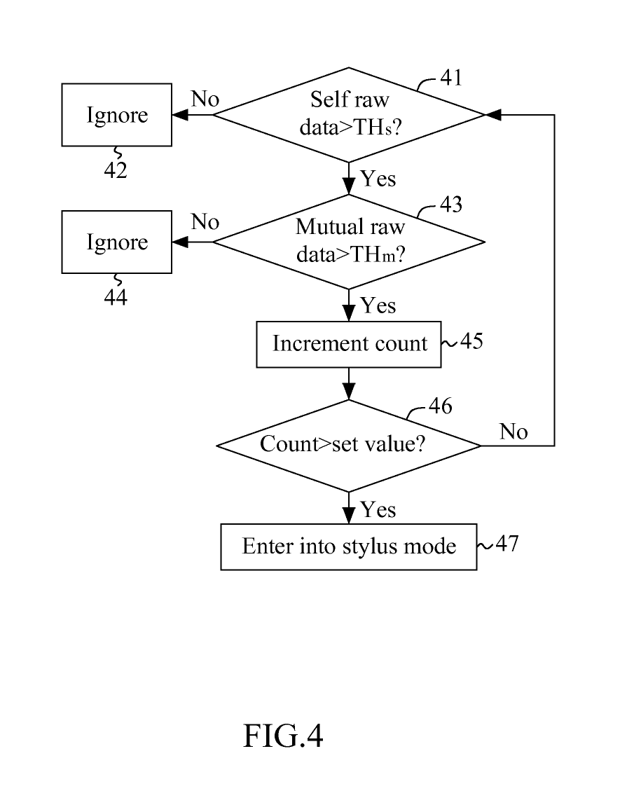

FIG. 4 shows a flow diagram of identifying touch action of a stylus according to one embodiment of the present invention. In step 41, self raw data associated with the self capacitance Cₛ (of one or more self scan cycles in a scan frame) is compared with the self touch threshold THₛ. If the result of step 41 is negative (i.e., the self raw data is not greater than THₛ), the touch action is ignored (step 42). Otherwise, the flow goes to step 43, in which the mutual raw data (in a scan frame) is compared with the mutual touch threshold THₘ. If the result of step 43 is negative (i.e., the mutual raw data is not greater than THₘ), the touch action is ignored (step 44); otherwise, in step 45, a count value is incremented. When the count value is not greater than a predetermined set value (a No branch of step 46), the flow goes back to step 41 for processing a succeeding scan frame. When the count value exceeds the predetermined set value (a Yes branch of step 46), a touch action is thus identified and the touch panel 100 enters into a stylus mode (step 47). As exemplified in FIG. 3A or FIG. 3B, the use of the count value in companion with the set value may prevent false touch identification due to spurious raw data. In the embodiment, according to the flow of FIG. 4, touch action is affirmatively identified only when the raw data becomes stable, that is, a predetermined times of larger-than-touch-threshold raw data has been met. After entering the stylus mode (alternatively speaking, exiting from a finger mode), some parameters may be adjusted. For example, the predetermined times of larger-than-touch-threshold raw data may be increased to enhance accuracy of touch identification. Moreover, in the stylus mode, algorithm may be restricted to single-touch identification instead of multi-touch identification in the finger mode.

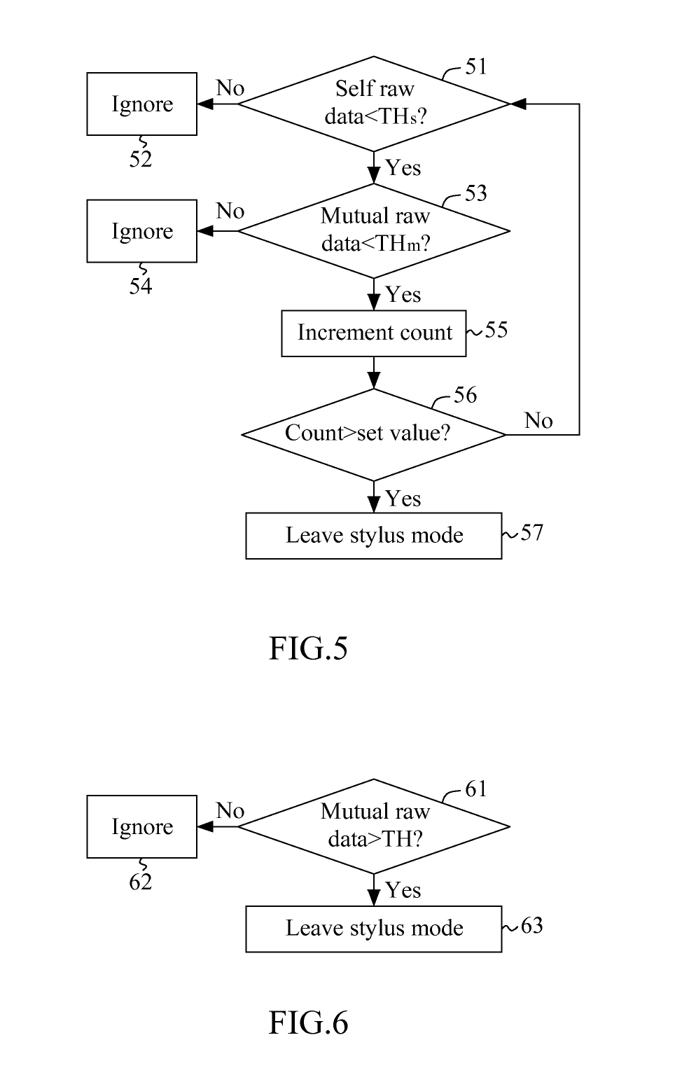

FIG. 5 shows a flow diagram of relieving touch action of a stylus (exiting from a stylus mode) according to one embodiment of the present invention. In step 51, self raw data associated with the self capacitance Cₛ (of one or more self scan cycles in a scan frame) is compared with the self touch threshold THₛ. If the self raw data is not less than THₛ, the self raw data is ignored (step 52). Otherwise, the flow goes to step 53, in which the mutual raw data (in a scan frame) is compared with the mutual touch threshold THₘ. If the mutual raw data is not less than THₘ, the mutual raw data is ignored (step 54); otherwise, in step 55, a count value is incremented. When the count value is not greater than a predetermined set value (a No branch of step 56), the flow goes back to step 51 for processing a succeeding scan frame. When the count value exceeds the predetermined set value (a Yes branch of step 56), a touch action of a stylus is thus relieved and the touch panel 100 leaves the stylus mode (step 57). As exemplified in FIG. 3A or FIG. 3B, the use of the count value in companion with the set value may prevent false touch action relief due to spurious raw data. In the embodiment, according to the flow of FIG. 5, touch action is affirmatively relieved only when the raw data becomes stable, that is, a predetermined times of less-than-touch-threshold raw data has been met.

FIG. 6 shows an alternative flow diagram of relieving touch action of a stylus (exiting from a stylus mode) according to another embodiment of the present invention. In step 61, mutual raw data (in a scan frame) associated with the mutual capacitance Cₘ is compared with a mutual threshold TH for finger touch in the finger mode. It is noted that the mutual threshold TH for finger touch may usually be greater than the mutual touch threshold THₘ for stylus touch in the stylus mode. If the mutual raw data is not greater than TH, the mutual raw data is ignored (step 62). Otherwise, if the mutual raw data is greater than TH, indicating a finger may probably touch the touch panel 100, a touch action of a stylus is thus relieved and the touch panel 100 leaves the stylus mode (step 63).

Although specific embodiments have been illustrated and described, it will be appreciated by those skilled in the art that various modifications may be made without departing from the scope of the present invention, which is intended to be limited solely by the appended claims.

What is claimed is:

1. A touch panel capable of detecting a stylus, comprising:
a plurality of row electrodes disposed along a first axis; and
a plurality of column electrodes disposed along a second axis, mutual capacitance being at every intersection of each row electrode and each column electrode, and self capacitance being at each row electrode and each column electrode;
wherein a voltage is applied to the column electrode or row electrode during a self scan cycle, and the stylus touching on a surface of the touch panel is measured on the same column electrode or row electrode; and a voltage is applied to one axis during a mutual scan cycle, and the stylus touching on the surface of the touch panel is measured on the other axis;
wherein at least one self scan cycle and at least one mutual scan cycle are performed in each scan frame, and touch identification of the stylus is affirmed when both touch identifications via the self scan cycle and the mutual scan cycle are detected.

2. The touch panel of claim 1, wherein self raw data associated with the self capacitance of a plurality of preceding scan frames are accumulated.

3. The touch panel of claim 1, wherein a plurality of same self scan cycles are performed in each scan frame, and self raw data of the self scan cycles are then added.

4. The touch panel of claim 3, wherein the touch identification of the stylus is affirmed when self raw data of the self scan cycles in a scan frame is greater than a predetermined self touch threshold for the stylus, and mutual raw data of the at least one scan cycle in the scan frame is greater than a predetermined mutual touch threshold for the stylus.

5. The touch panel of claim 3, wherein relief of touch action of the stylus is affirmed when self raw data of the self scan cycles in a scan frame is less than a predetermined self touch threshold for the stylus, and mutual raw data of the at least one scan cycle in the scan frame is less than a predetermined mutual touch threshold for the stylus.

6. The touch panel of claim 1, wherein relief of touch action of the stylus is affirmed when mutual raw data of the at least one scan cycle in the scan frame is greater than a predetermined mutual touch threshold for a finger.

7. The touch panel of claim 1, wherein a touch action of the stylus is affirmatively identified when self raw data associated with the self capacitance and mutual raw data associated with the mutual capacitance become stable.

8. The touch panel of claim 1, wherein an identified touch action is affirmatively relieved when self raw data associated with the self capacitance and mutual raw data associated with the mutual capacitance become stable.

9. A method of using a touch panel to detect a stylus, comprising:
providing a plurality of row electrodes disposed along a first axis;
providing a plurality of column electrodes disposed along a second axis, mutual capacitance being at every intersection of each row electrode and each column electrode, and self capacitance being at each row electrode and each column electrode;
applying a voltage to the column electrode or row electrode during a self scan cycle, and the stylus touching on a surface of the touch panel is measured on the same column electrode or row electrode;
applying a voltage to one axis during a mutual scan cycle, and the stylus touching on the surface of the touch panel is measured on the other axis; and
performing at least one self scan cycle and at least one mutual scan cycle in each scan frame, touch identification of the stylus being affirmed when both touch identifications via the self scan cycle and the mutual scan cycle are detected.

10. The method of claim 9, further comprising a step of accumulating self raw data associated with the self capacitance of a plurality of preceding scan frames.

11. The method of claim 9, further comprising:
performing a plurality of same self scan cycles in each scan frame; and
adding self raw data of the self scan cycles.

12. The method of claim 11, wherein the touch identification of the stylus is affirmed when self raw data of the self scan cycles in a scan frame is greater than a predetermined self touch threshold for the stylus, and mutual raw data of the at least one scan cycle in the scan frame is greater than a predetermined mutual touch threshold for the stylus.

13. The method of claim 11, wherein relief of touch action of the stylus is affirmed when self raw data of the self scan cycles in a scan frame is less than a predetermined self touch threshold for the stylus, and mutual raw data of the at least one scan cycle in the scan frame is less than a predetermined mutual touch threshold for the stylus.

14. The method of claim 9, wherein relief of touch action of the stylus is affirmed when mutual raw data of the at least one scan cycle in the scan frame is greater than a predetermined mutual touch threshold for a finger.

15. The method of claim 9, wherein a touch action of the stylus is affirmatively identified when self raw data associated with the self capacitance and mutual raw data associated with the mutual capacitance become stable.

16. The method of claim 9, wherein an identified touch action is affirmatively relieved when self raw data associated with the self capacitance and mutual raw data associated with the mutual capacitance become stable.
